(19) United States
(12) Patent Application Publication
(10) Pub. No.: US 2007/0257396 A1
(43) Pub. Date: Nov. 8, 2007

(54) DEVICE AND METHOD OF FORMING NANOIMPRINTED STRUCTURES

(76) Inventors: Jian Wang, Orefield, PA (US); Lei Chen, Princeton, NJ (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/381,949

(22) Filed: May 5, 2006

(51) Int. Cl. B29C 33/40; B29C 71/00; B29C 41/02; C23F 1/00; B29C 59/02

(52) U.S. Cl. 264/219; 264/236; 264/320; 216/41

(57) ABSTRACT

A novel method of forming a nanostructure device is provided. A master having a nanostructure layer is used to make an intermediate replica. The intermediate replica includes a pattern layer and a buffer layer, both made from viscous material. The depth of the buffer layer is at least ten times greater than the depth of the pattern layer such that the buffer layer absorbs any dust particles that may be present. The intermediate replica, rather than the master, is then used to make the final nanostructure device.

### TECHNICAL FIELD

The present invention relates to a process of making nanostructure devices and more particularly to nanoimprint lithography.

### BACKGROUND OF THE INVENTION

Nanoimprint lithography (NIL) may generally be described as a lithographic method designed to create ultra-fine patterns of sub-micron features in a thin film coated on a surface. The process involves a master mold having a desired pattern of nanostructures being mechanically pressed into a thin film of resist material applied over a target layer. The mechanical pressing by the master mold creates a negative pattern on the resist material. The pattern in the resist material is transferred into the target layer using a technique such as reactive ion etching (RIE) or plasma etching.

NIL for forming nanostructures such as semiconductor integrated electrical circuits is well known in the art. One example of NIL is described in U.S. Pat. No. 4,512,848 ('848 patent), issued to Deckman, incorporated herein by reference.

One exemplary method of forming nanostructures using NIL is shown in FIGS. 1A-1D. A nanostructure device for purposes of the present application is defined to be a device in which the structures formed therein has a minimum feature size of less than 1 micron. FIG. 1A shows a master mold 10 including a carrier substrate 12 and a nanostructure layer 14 having a plurality of features to be transferred. The depth of the features in the nanostructure layer 14 in FIG. 1A is shown to be about 50 nm.

A target structure 18 to which the pattern in the master mold is transferred includes a target layer 20 and a substrate 22 that carries the target layer. A resist layer 24 having a low viscosity is deposited or formed on the target layer 20. Typically, the thickness of the resist layer 24 is about the same as or somewhat higher than the depth of the features to be replicated. For example, to pattern a feature having a depth of about 50 nm, the resist should be about 100 nm thick. A possible thickness range for the resist layer 24 is 50 nm-300 nm.

Once the resist layer 24 is applied, the master mold 10 is lightly pressed into the resist layer 24 as shown in FIG. 1B to create a negative impression of the pattern in the nanostructure layer 14 leaving a residual layer 26 due to the viscosity nature of the resist material. The residual layer 26 is part of the resist layer 24. After being pressed, the resist material is solidified through curing. Different curing methods are used depending on the resist material being used. If a UV-curable resist material is used, then curing involves exposing the resist material to ultra violet light. If a thermally curable resist material is used, curing involves heating the resist material. The resist material can also be a thermal plastic material. Heated to above its glass transition temperature (Tg), the viscosity of the thermal plastics is significantly reduced, which allows it to be molded. The pattern can be fixed after the temperature is lowered below Tg. Although curable resist material is used through this disclosure, a thermal plastic material can also be used to achieve the same result as the curable resist material.

Thereafter, the master mold 10 is removed from the target structure 18 as shown in FIG. 1C. Separation may be facilitated by applying a pressurized air or a pressurized gas stream at a side interface between the master mold 10 and the cured resist layer 24. Upon separation of the resist layer 24 from the master mold 10, a negative replication of the pattern in the resist layer 24 is revealed.

The resist layer 24 is then used as a mask for etching the target layer 20. Specifically, the residual layer 26 and then the target layer 20 are etched using any of the well-known etching techniques such as Reactive Ion Etching (RIE). Depending on the etching characteristics of the residual layer 26 and target layer 20, different etching agent may need to be used for each layer. The final nanostructure device 18 is shown in FIG. 1D which shows the patterned target layer 20 overlying the substrate 22. Although the target layer 20 as shown is a negative replication of the pattern layer of the master mold 10, the target layer could be deeper or shallower or even wider/narrower than original negative replication of the pattern layer from the master mold 10. The etch process and pattern transfer process determines the target layer shape.

In manufacturing nanostructures, particles and contaminations play a large role in yield efficiency. As feature size to be replicated becomes smaller and smaller, e.g., on the order of 100 nm or smaller, particles become an even bigger problem because even an extremely small particle on the order of 50 nm can cause imprint defects generally known as particle-associated defects (PAD's). As shown in FIG. 2, particles 28 cause the pattern in the master mold 10 to be incorrectly transferred to the resist layer 24. Even though the particles appear to only affect a small area of approximately 50 nm, the affected area becomes magnified by several orders of magnitude in the process of transferring the pattern to the target layer 20. This results in a lower yield of the nanostructure devices. The yield problem becomes particularly acute in fabricating complex nanostructures having multiple pattern layers such as in a semiconductor integrated circuit device because even one relatively small sized particle in any one layer can ruin the entire nanostructure device.

Moreover, as shown in FIG. 2, particles 28 can damage the delicate nanostructure layer 14 in the master mold 10. This is because the master mold 10 and the target layer 20 are generally made of hard materials such as silicon, glass, nickel shim or the like. When two hard materials come in contact with a very thin and soft resist layer 24 to imprint the pattern, the particle can press against the master mold 10 with a sufficient force to damage fine pattern. As the cost of each master mold is in the tens of thousands of dollars or even in the million dollar range, the conventional method of NIL becomes very expensive in fabricating nanostructure devices.

Therefore, it would be desirable to have a device and method for increasing the life of the master mold and increasing the manufacturing yield of the nanostructure devices, thereby reducing the overall manufacturing cost.

### SUMMARY OF THE INVENTION

According to the principles of the present invention, a novel method of forming a nanostructure device is provided. A master having a nanostructure pattern is formed. The master is used to make an intermediate replica of the master. The intermediate replica includes a relatively thick buffer layer and a pattern layer overlying the buffer layer. The depth of the buffer layer is at least ten times greater than the depth of the pattern layer. The intermediate replica, rather than the master, is then used to make the final nanostructure device.

According to another aspect of the invention, an intermediate mold for use in forming a nanostructure device is provided. The intermediate mold is a replica of a master mold and has a pattern layer having a pattern to be transferred to the nanostructure device and a relatively thick buffer layer underlying the pattern layer. The depth of the buffer layer is at least ten times the depth of the pattern layer of the intermediate mold.

### BRIEF DESCRIPTION OF THE DRAWINGS

FIGS. 1A through 1D illustrates a process of forming a nanostructure device using NIL.

FIG. 2 shows a schematic diagram that illustrates the effect of dust particles during NIL.

FIGS. 3A-3D illustrates a process of forming a nanostructure device according to the present invention.

### DETAILED DESCRIPTION OF THE INVENTION

According to the invention, a master mold holding a nanostructure pattern is replicated to an intermediate mold having a thick buffer layer such that any particles that are trapped between the master mold and the intermediate mold during the replication process are pushed down into the buffer layer. The intermediate mold is then used to fabricate the final nanostructure device. As compared to the master mold whose cost is in the range of $1,000 to $1,000,000, the cost of an intermediate mold is usually about $100 or less. As a result the present invention increases the life of the master mold and increases the manufacturing yield.

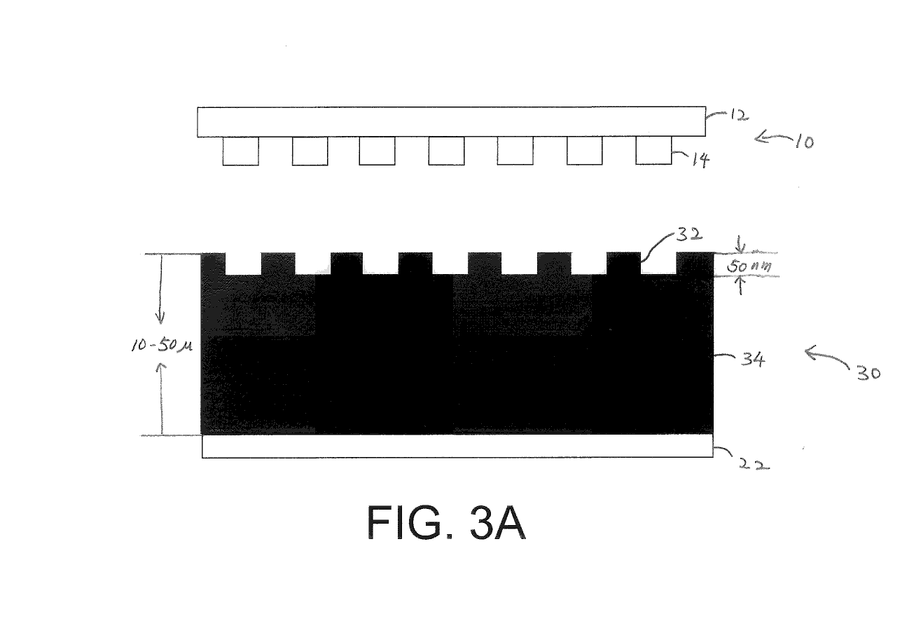

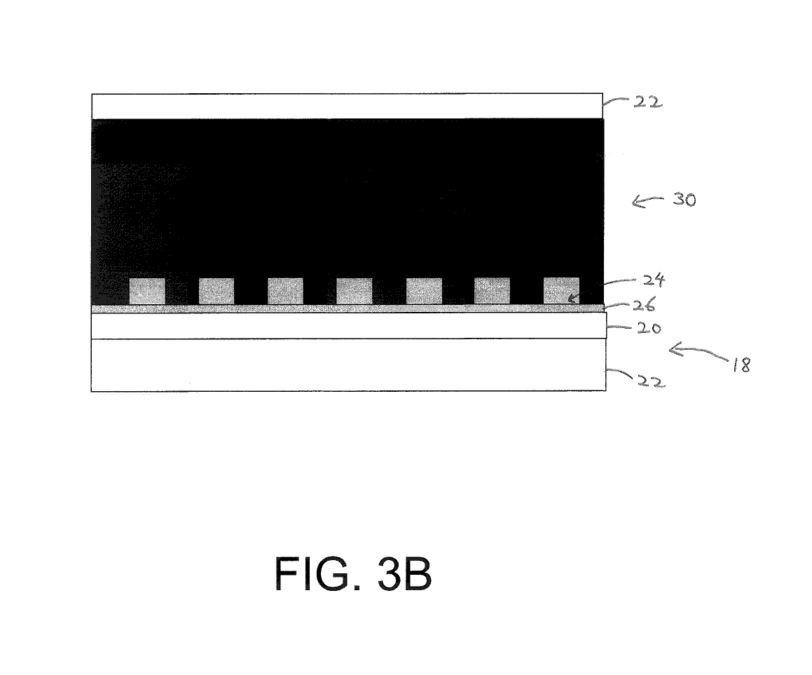

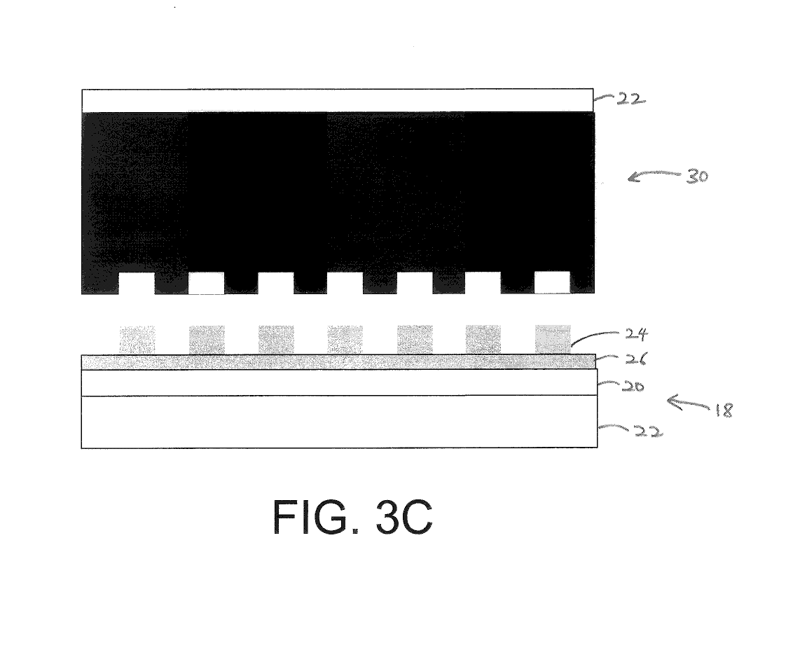

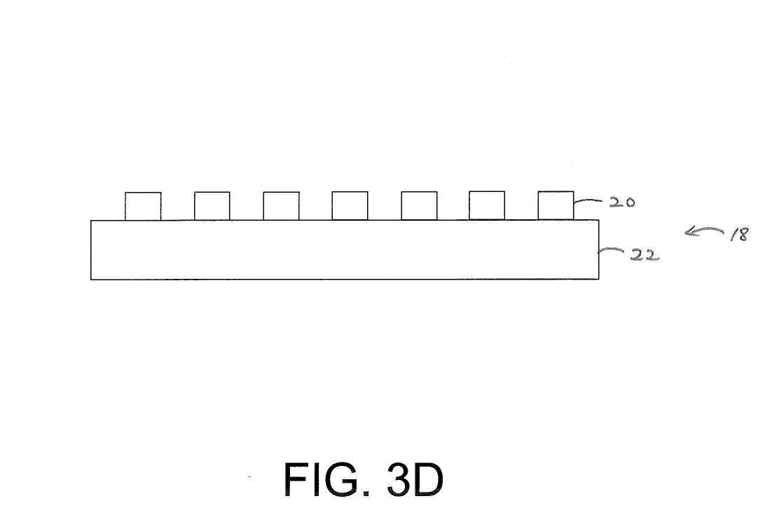

As shown in FIG. 3A, an intermediate mold 30 includes an intermediate pattern layer 32, a buffer layer 34 and a substrate 22 supporting the pattern and buffer layers. The pattern layer 32, which contains a replica of the nanostructure layer 14 of the master mold 10, can be the same material as the resist layer 24 or different material.

The pattern layer 32, which is a type of composition that is capable of transformation, with or without a physical treatment, into a polymer unit is provided. According to an aspect of the invention, the pattern layer 32 has a polymerizable composite so that it may be polymerized to retain the mold shape. Thus, in this aspect, it may be necessary to use a polymerizable compound or precursor of a polymer as part of the polymerizable composite of a liquid layer composition. For example, polymerizable monomers or oligomers, or a combination thereof, can be used as building blocks so that a homopolymer or a copolymer is obtained. There are a great number of polymerizable compounds known to one skilled in the art. These include, for example, organic materials (or composites) such as epoxy, methyl acrylate, acrylamide, acrylic acid, vinyl, ketene acetyl groups containing monomers, oligomers and inorganic composites such as silicon, aluminum and other metallic or semi-metallic composites. A suitable polymerizable composite may include at least one polymerizable compound or precursor and optionally a diluent and/or a solvent. A diluent is not the same as a solvent for purposes of this invention. Diluent as used herein refers to one of the reactive components which is one of the components and forms part of the final film. Solvent is not intended to be part of the final film. The solvent may be used to control the viscosity of the liquid layer composition and the use of a solvent in the final composition is optional depending on the coating process. For example, solvent may be needed to modulate the viscosity of a composition used for spin coating a substrate. Typical solvents that may be use include toluene, dimethyl formamide, chlorobenzene, xylene, dimethyl sulfoxide (DMSO), dimethyl formamide, dimethyl acetamide, dioxane, tetrahydrofuran (THF), methylene chloride, ethylene chloride, carbon tetrachloride, chloroform, lower alkyl ethers such diethyl ether and methyl ethyl ether, hexane, cyclohexane, benzene, acetone, ethyl acetate, and the like. The boiling a solvent or solvent mixture can be, for example, below 200 C. Selection of suitable solvents for a given system will be within the skill in the art and/or in view of the present disclosure.

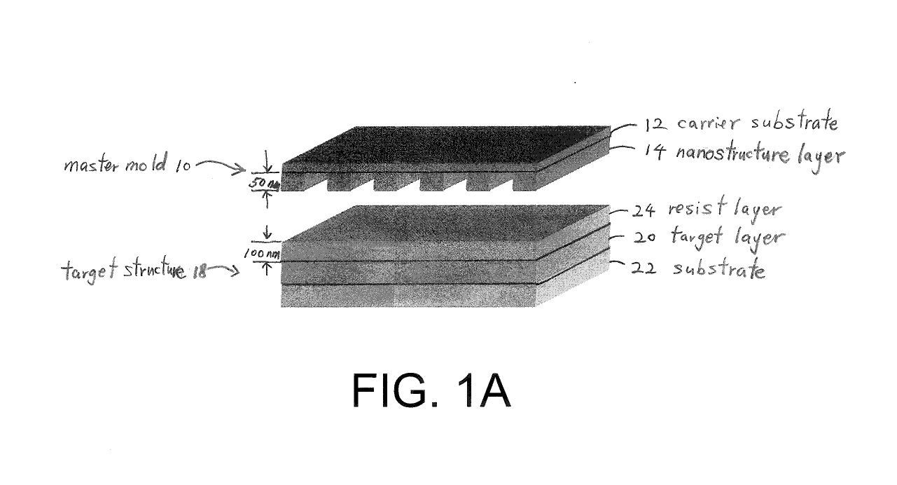

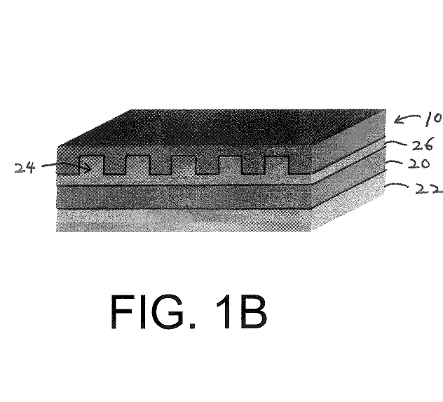

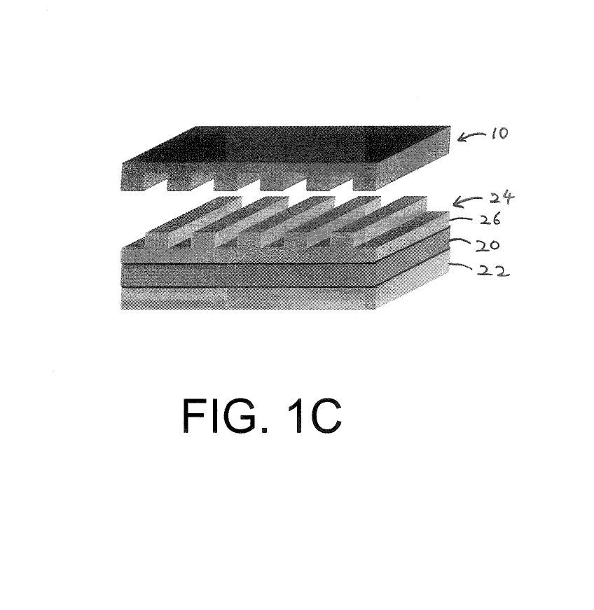

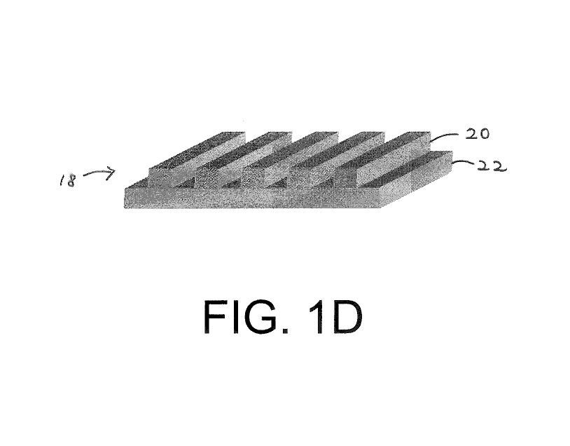

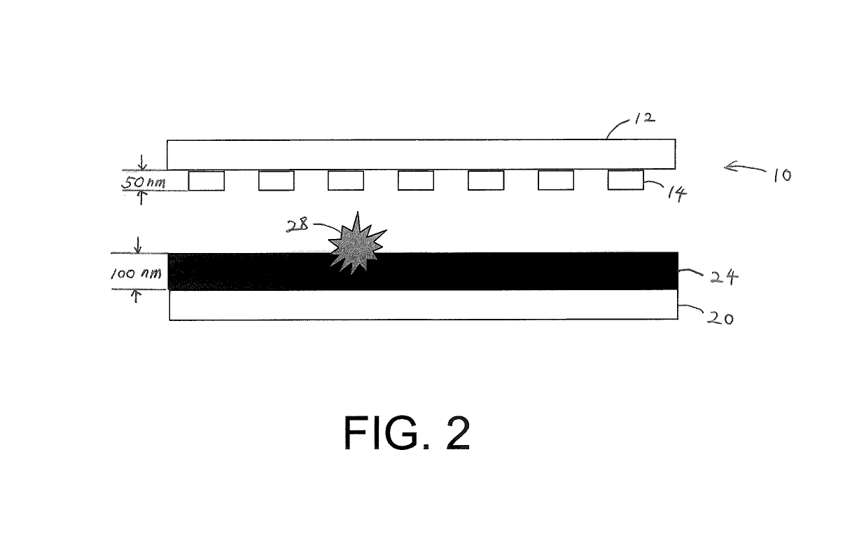

Forming the intermediate mold 30 is similar to the steps as shown in FIGS. 1A-1C. A liquid resist layer 32 and buffer layer 34 are applied over the substrate 22. If the resist materials used in the layers 32 and 34 are different, then the buffer layer 34 is applied over the substrate 22 first. And then, the liquid resist layer 32 is applied over the buffer layer 34. Then, the master mold 10 is lightly pressed into the resist layer 32 as shown in FIG. 3A to create a negative impression of the pattern in the resist layer 32. After being pressed, the resist material is cured in order to change its state from liquid to solid. Thereafter, the master mold 10 is removed from the intermediate mold 30 to define a pattern layer 32 and buffer layer 34. Upon separation of the master mold 10 from the resist layer 32, a negative replication of the pattern in the nanostructure layer 14 is formed in the pattern layer 32 in the intermediate mold 30.

According to the invention, the depth of the buffer layer 34 is at least ten times as high as the depth of the pattern layer 32. For example, the depth of the buffer layer can be 500 nm or higher while that of the pattern layer can be 50 nm. This is to ensure that any dust particles that settle on the liquid resist layer are pushed down into the buffer layer 34 so as not to interfere with forming accurate features in the pattern layer 32. Preferably, the ratio of the depth of the buffer layer 34 to the depth of the pattern layer 32 is at least 200:1 and is between 200:1 and 1000:1. Depending on the type of resist materials used for the pattern layer 32 and buffer layer 34, to initially hold the liquid or semi-liquid resist layer 32 and buffer layer 34, a container having vertical sidewalls may be used to hold the liquid in its place over the substrate 22 if the depth ratio is very high.

In FIG. 3A, the depth of the pattern in the pattern layer 32, i.e., the depth of each feature, is 50 nm while the depth of the buffer layer 34 is between 10 microns and 50 microns.

As shown in FIGS. 3B and 3C, the intermediate mold 30, rather than the master mold 10, is then used to fabricate the final nanostructure device 18. Preferably, each intermediate mold 30 is used to make at least one to ten nanostructure devices 18.

The liquid resist layer 24 is applied on the target layer 20 overlying the substrate 22. Once the resist layer 24 is applied, the intermediate mold 30 is lightly pressed into the resist layer 24 to create a negative impression of the pattern in the resist layer while leaving a residual layer 26. After being pressed, the resist material is cured in order to change its state from liquid to solid. As discussed above, different curing methods are used depending on the resist material being used.

Thereafter, the intermediate mold 30 is removed from the target structure 18 as shown in FIG. 3C. Separation may be facilitated by applying a pressurized air or a pressurized gas stream at a side interface between the intermediate mold 30 and the cured resist layer 24. Upon separation of the resist layer 24 from the intermediate mold 30, a negative replication of the pattern in the resist layer 24 from the pattern in the intermediate mold 30 is revealed.

The resist layer 24 is then used as a mask for etching the target layer 20. Specifically, the residual layer 26 and then the target layer 20 are etched using any of the well-known etching techniques. The final product is shown in FIG. 3D which shows the patterned target layer 20 overlying the substrate 22.

Typically, either the source pattern layer or target layer or both are treated with a mold release agent, to reduce sticking forces between the source layer and the cured target layer, to ease separation. Suitable treatments may include siloxane or fluorinated release agents. Such treatments may be additionally applied within or to the target layer. By way of specific non-limiting example, the source layer 14 of FIG. 3A or layer 32 of FIG. 3C may be surface treated with a mold release agent by solvent dipping, vapor evaporation and plasma based or other chemical vapor deposition, for example. The mold release agent may take the form of commercially available perfluorodecyltrichlorosilane, for example.

By manufacturing nanostructures using an intermediate mold having a thick buffer layer, the present invention, substantially reduces defects in the nanostructures, decreases manufacturing costs and increases the life of the master mold.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A method of forming a nanostructure device comprising:
forming a master having a nanostructure layer, the nanostructure layer defining a pattern of nanostructures to be transferred; and
forming an intermediate replica of the master for use in forming the nanostructure device, the intermediate replica having a buffer layer and a pattern layer overlying the buffer layer, the depth of the buffer layer being at least ten times greater than the depth of the pattern layer of the intermediate replica.

2. The method according to claim 1, wherein the step of forming an intermediate replica of the master includes:
pressing the nanostructure layer of the master into a moldable layer;
solidifying the moldable layer while the nanostructure layer is being pressed against the moldable layer so as to transfer the pattern in the nanostructure layer to the moldable layer, the solidified moldable layer defining both the pattern layer and the buffer layer of the intermediate replica; and
removing the master from the solidified moldable layer.

3. The method according to claim 1, wherein the step of forming an intermediate replica of the master includes:
contacting the nanostructure layer of the master with a curable layer;
curing the curable layer while the nanostructure layer of the master is in contact with the curable layer so as to transfer the pattern in the nanostructure layer to the curable layer, the cured layer defining the pattern layer of the intermediate replica; and
removing the master from the cured layer.

4. The method according to claim 1, wherein the step of forming an intermediate replica of the master includes forming the intermediate replica with the buffer layer whose depth is at least two hundred times greater than the depth of the nanostructure layer.

5. The method according to claim 1, wherein the step of forming an intermediate replica of the master includes forming the intermediate replica with the buffer layer whose depth is greater than the depth of the nanostructure layer to be transferred by at least two hundred times and at most one thousand times.

6. The method according to claim 1, further comprising transferring the pattern layer of the intermediate replica over the substrate of the nanostructure device.

7. The method according to claim 6, wherein the step of transferring the pattern layer includes:
applying a resist layer over the substrate of the nanostructure device;
forming an imprint of the pattern layer of the intermediate replica on the resist layer of the nanostructure device; and
etching the imprinted nanostructure device to transfer the pattern layer.

8. A method of forming a nanostructure device comprising:
transferring a nanostructure layer of a master mold to a pattern layer of an intermediate mold, the nanostructure layer defining a pattern of nanostructures to be transferred, the intermediate mold including a buffer layer wherein the depth of the buffer layer is at least ten times greater than the depth of the pattern layer, the pattern and buffer layers being made of solidified viscous material; and
transferring the pattern layer in the intermediate mold to the nanostructure device.

9. The method according to claim 8, wherein the step of transferring a nanostructure layer of a master mold to a pattern layer of an intermediate mold includes:
pressing the nanostructure layer of the master mold into a moldable layer of the intermediate mold;
solidifying the moldable layer while the nanostructure layer of the master mold is being pressed into the moldable layer so as to transfer the pattern of nanostructures in the nanostructure layer to the moldable layer, the solidified moldable layer defining both the pattern layer and the buffer layer of the intermediate mold; and
removing the master mold from the solidified moldable layer.

10. The method according to claim 8, wherein the step of transferring a nanostructure layer of a master mold to a pattern layer of an intermediate mold includes:
contacting the pattern layer of the master mold with a curable layer;
curing the curable layer while the nanostructure layer of the master mold is in contact with the curable layer so as to transfer the nanostructure layer to the curable layer, the cured layer defining the pattern layer and buffer layer of the intermediate mold; and
removing the master mold from the cured layer.

11. The method according to claim 8, wherein the step of transferring a nanostructure layer of a master mold to a pattern layer of an intermediate mold includes forming the intermediate mold with the buffer layer whose depth is at least two hundred times greater than the depth of the nanostructure layer.

12. The method according to claim 8, wherein the step of transferring a nanostructure layer of a master mold to a pattern layer of an intermediate mold includes forming the intermediate mold with the buffer layer whose depth is greater than the depth of the nanostructure layer to be transferred by at least two hundred times and at most one thousand times.

13. The method according to claim 8, wherein the step of transferring the pattern layer in the intermediate mold to the nanostructure device includes:
applying a resist layer over the substrate of the nanostructure device;
forming an imprint of the pattern layer of the intermediate mold on the resist layer of the nanostructure device; and
etching the imprinted nanostructure device to transfer the pattern layer

14. An intermediate mold for use in forming a nanostructure device comprising:
a pattern layer having a pattern of nanostructures to be transferred to the nanostructure device, the pattern layer being a replica of a nanostructure layer of a master mold; and
a buffer layer underlying the pattern layer, wherein the depth of the buffer layer is at least ten times the depth of the pattern layer, wherein the nanostructures and the buffer layer made of cured viscous material.

15. The intermediate mold according to claim 14, wherein the pattern and buffer layers are formed of a polymer material.

16. The intermediate mold according to claim 14, wherein the depth of the buffer layer is at least two hundred times greater than the depth of the pattern layer.

17. The intermediate mold according to claim 14, wherein the depth of the buffer layer is greater than the depth of the pattern of nanostructures by at least two hundred times and at most one thousand times.
